(19) United States
(12) Patent Application Publication
(10) Pub. No.: US 2021/0327250 A1
(43) Pub. Date: Oct. 21, 2021

(54) METHODS AND APPARATUS FOR ITEM LOCATION

(71) Applicant: GPS of Things, Inc., San Jose, CA (US)

(72) Inventors: Christopher J. Waters, San Jose, CA (US); Brent R. Humphrey, San Jose, CA (US)

(21) Appl. No.: 17/231,290

(22) Filed: Apr. 15, 2021

Related U.S. Application Data
(60) Provisional application No. 63/011,724, filed on Apr. 17, 2020.

(51) Int. Cl. G08B 21/24; G06Q 10/10; G06Q 50/28; B64C 39/02; B60W 60/00; B63B 79/40; G01D 21/02

(52) U.S. Cl. CPC G08B 21/24; G06Q 10/10; G06Q 50/28; G06K 19/0723; B60W 60/00259; B63B 79/40; G01D 21/02; B64C 39/024

(57) ABSTRACT

Methods and apparatus for item location management are described.

### CROSS-REFERENCE TO RELATED APPLICATIONS

This application claims the benefit of U.S. Provisional Patent Application No. 63/011,724, filed Apr. 17, 2020, the entire contents of which is hereby incorporated by reference.

### BACKGROUND

The need for tracking technology in household, commercial, and industrial objects continues to grow as the amount of objects that we need to keep track of expands. Several problems exist that make the tracking of everyday items (e.g. drill bits, articles of clothing, pets, camping gear) prohibitive. Current tracking technologies of household objects can be expensive to implement in large quantities for one reason because device commissioning currently requires a significant amount of manual operations and user inputs. Additionally, many tracking technologies that are in use today may be less effective at tracking household objects that reside inside buildings and other containers.

### BRIEF DESCRIPTION OF THE DRAWINGS

Embodiments and implementations of the present disclosure will be understood more fully from the detailed description given below and from the accompanying drawings of various aspects and implementations of the disclosure, which, however, should not be taken to limit the disclosure to the specific embodiments or implementations, but are for explanation and understanding only.

FIG. 1A illustrates a first example tracking and management system in accordance with various embodiments of the present disclosure.

FIG. 1B illustrates a second example tracking and management system specifically using drones in accordance with various embodiments of the present disclosure.

FIG. 2 is a flow diagram of a method of locating an item in accordance with some embodiments.

FIG. 3 is a flow diagram of a method of generating a list of items and indicating the locations of the items associated with a task in accordance with some embodiments.

FIG. 4 is a flow diagram of a method of automatically creating a group between devices through automatic device commissioning in accordance with some embodiments.

FIG. 5 is a flow diagram of a method of configuring devices to specific properties in accordance with some embodiments.

FIG. 6 is a block diagram of an example computer system that may perform one or more of the operations described herein in accordance some embodiments.

FIG. 7 illustrates one embodiment of a methodology of keep together functionality in accordance with some embodiments.

FIG. 8 illustrates one embodiment of a Smart straw in accordance with some embodiments.

FIG. 9 is a flow diagram of a method of using a Smart straw in accordance with some embodiments.

FIG. 10 illustrates one embodiment of a Smart plate in accordance with some embodiments.

FIG. 11 is a flow diagram of a method of using a Smart plate in accordance with some embodiments.

FIG. 12 illustrates one embodiment of a Smart liquid container in accordance with some embodiments.

FIG. 13 is a flow diagram of a method of using a Smart liquid container in accordance with some embodiments.

### DETAILED DESCRIPTION

People often struggle to keep track of items both inside and outside their homes, workplaces, facilities, and commercial and industrial buildings. A significant contributor to this struggle is the inability to monitor the location of these items. A person may establish systems of sorting and organizing items in order for the person to locate the items quickly. In certain situations, however, items can be misplaced or lost, thereby rendering the systems of sorting and organizing the items ineffective. For example, if an item is placed in the wrong location or the item is forgotten at a remote location, then the location of the item may not be readily apparent.

A system and method are described that can track and manage the location and contents of items that are introduced into an inventory of items. In one embodiment, a transponder affixed to the new item transmits an identification signal that enables the tracking and monitoring of the new item by a location module. The location module maintains an inventory of items and corresponding properties of the items. When the new item affixed with a transponder is introduced to the inventory of items, the identification signal is received by the location module and the location module determines that the identification signal is unregistered in the inventory of items. The location module extracts from the identification signal properties associated with the new item. The location module generates an updated list to include the unregistered identification signal and the extracted proper ties associated with the new item. In addition to items, lists can contain context sensitive suggestions based on activity, travel route, destination or other means. A user may wish to use an activity based list manager that can be used as is or modified by the user to manage lists created.

In one embodiment, the location module receives a location request for an item from a user. Using the identification signal of the item, the location module determines the items location. The location module may present to the user, through a graphical user interface, a map of an area with an indicator showing the location of the item. The location module may send a command to the transponder affixed to the item, causing the transponder to announce the items presence through the use of flashing one or more lights, emitting one or more sounds, vibrating one or more items or devices, or through one or more other indicators.

The location module also tracks and monitors the identification signals associated with items in order to determine usage patterns for the items. By tracking the movement of the identification signals associated with the items, the location module determines which items are used more frequently. In one embodiment, the location module may present recommendations and advertisements for items based on which items are used more frequently. For example, if the location module determines that a user frequently drinks coffee, the location module may present the user with recommendations and advertisements tailored towards coffee drinkers. The location module may also provide the user with a notification if a tracked item needs to be restocked or replaced. Alternatively, the location module can generate an order for an item in response to determining that an item needs to be replaced. In one embodiment, Smart containers or drones have the ability to identify, count, and classify items. In instances where a drone may identify an item as dangerous, a security module may relay this information to the proper authorities. In another embodiment, one or more Smart tags may be used on items to provide detailed assessments of the contents of items. Smart tags are mobile battery powered devices comprised of an intelligent microcontroller or microprocessor, one or more wireless communication capabilities such as Bluetooth Low Energy and cellular data communication, sensors for monitoring environmental conditions and/or motion further they may or may not contain GPS/GNSS location capability. The Smart Tags have the ability to communicate with each other to work in a cooperative manner where smaller lower cost Smart Tags may leverage the higher end communication capability of the larger costlier Smart tags. These Smart tags may have the ability to determine the amount of fluid in an item, for an example. The information provided by the Smart tags may be extracted by a property module, which in turn may formulate lists based on the data received by the Smart tags. Further details describing the operation of the inventory tracking and management system and methods are provided below.

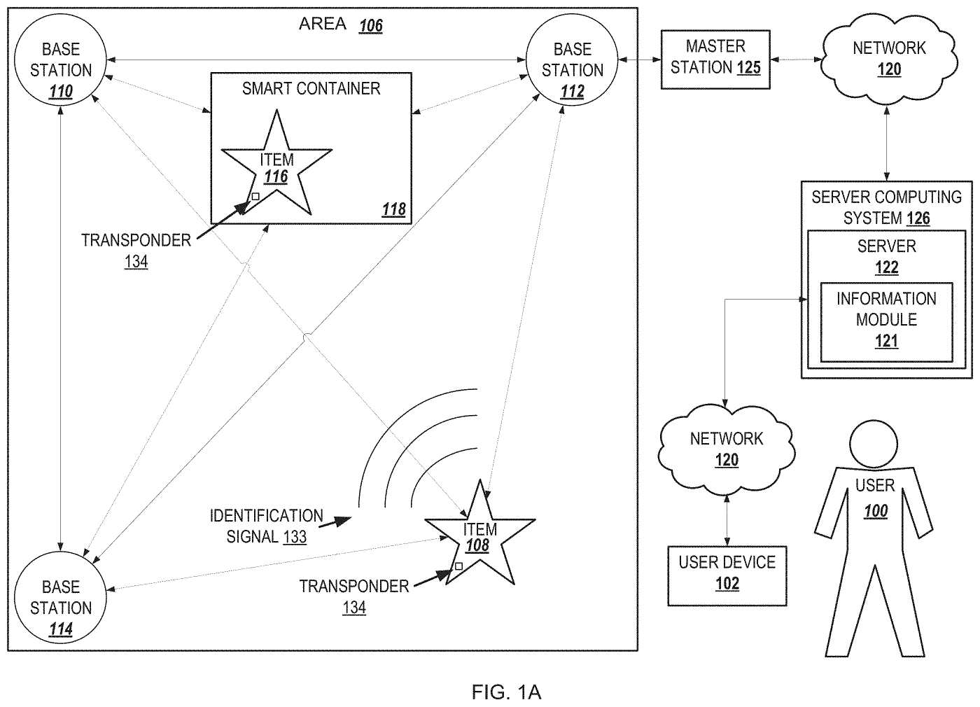

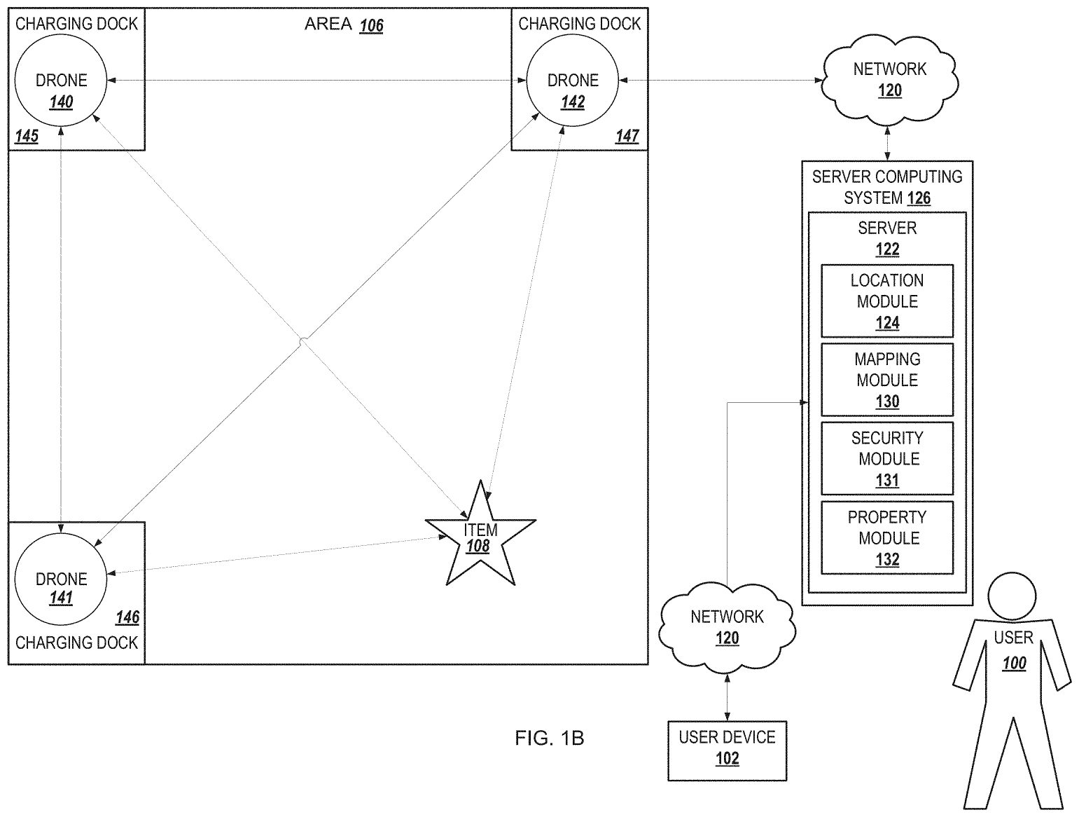

FIG. 1A illustrates a first example tracking and management system in accordance with various embodiments of the present disclosure. A user 100 may request the location 104 of an item 108 in an area 106. The item 108 of which a location may be requested may include one or more Smart labels and/or one or more Smart tags. The Smart label may be a transponder 134 that transmits an identification signal 133 associated with the item 108. Smart labels may include locating technology (e.g. geographical information systems (GIS), global positioning system (GPS), Bluetooth®, radio frequency identification (RFID), near field communication (NFC), local area wireless (WLAN, Wi-Fi), local area network (LAN), Global System for Mobile Communications (GSM), and the like). In some embodiments, Smart labels are transponders 134 that may be affixed to the item 108 that the user 100 may want to locate. In another embodiment, Smart labels are transponders 134 built into the item 108 during production of the item.

In one embodiment, Smart labels include a user-replaceable battery. In another embodiment, Smart labels do not include a user-replaceable battery and are instead powered using inductance technologies. Other methods of powering may be utilized to provide power to Smart labels such as motion, photovoltaic, or micro fuel cell. Energy storage can include compressed air, butane, methane, and other more traditional battery cell technologies. In another embodiment, Smart labels may include other systems such as a lighting system (e.g. light-emitting diode (LED)), vibration system, motion detection system, sound system, and a graphics display system (e.g. video display). Smart labels may also include a touchscreen, buttons, and other user input systems. In one embodiment, Smart labels utilize mass spectrometry to characterize physical, material, fabric color, and other attributes of the item to which they are affixed. Smart labels may also utilize additional sensors to measure characteristics such as gyroscope, magnetometer, accelerometer, altitude, temperature, humidity, atmospheric pressure or others.

The Smart labels may be customized with information. A user 100 may want to associate a category with an item. In one embodiment, more than one category may be associated with an item. For example, in the case of a backpack, a user 100 might want to customize the backpack's Smart label to include the category “school.” In another example, a user 100 might want to customize the same backpack's Smart label to include the categories “school” and “hiking.” Other information may also be stored on a Smart label. For instance, a user 100 might want to define a “home base” for an item, and customize its Smart label to reflect that choice. A home base is a location where the item should reside. Setting a home base allows a user 100 to receive notifications when the item is not at its home base. In one embodiment, multiple home bases may be customized and timing information as to when an item should be at various locations may also be set. In one embodiment, a user 100 may continually re-customize a Smart label as needs change. Alternatively, a Smart label may only be customized only once. It should be noted that in one embodiment, a home base may also be used as a charging station.

In one embodiment, base stations 110, 112, 114 are spread throughout area 106 so that every Smart label contained in area 106 is in communication range of three or more base stations 110, 112, 114. Base stations 110, 112, 114 are devices capable of transmitting and receiving item locating technology signals and can be line powered, battery powered, air powered, gas powered, inductively powered, wirelessly powered or powered through other means. The base stations 110, 112, 114 are also capable of determining air temperature and quality. In one embodiment, base stations 110, 112, 114 are communicatively coupled to a master station 125. The master station 125 is a device capable of receiving and transmitting signals to and from base stations 110, 112, 114. The master station 125 may be communicatively coupled to a server 126 via a network 120. In one embodiment, the master station 125 may maintain a local inventory of system components (e.g., Smart labels, Smart tags, base stations, Smart containers, drones, etc.). In one embodiment, a user 100 sends a location request to an information module 121 on server 122 of server computing system 126 via user device 102. The information module 121 may further comprise a location module 124, a mapping module 130, a security module 131, and/or a property module 132 (as detailed in FIG. 1B). Therefore, a user 100 sends a location request for an item to location module 124 on server 122 of server computing system 126 via user device 102. Computing systems described herein (e.g. 126) are each capable of communicating with one another via network 120. In another embodiment, user device 102 may communicate directly with base stations 110, 112, 114 via network 120 and the base station 120. In this embodiment, location module 124 may reside on user device 102. Network 120 may include, for example, private network such as a local area network (LAN), a wide area network (WAN), a global area network (GAN) such as the Internet, or a combination of such networks, and may include a wired or wireless network. Various networks described herein may be the same network or different networks altogether.

In one embodiment, once a location request for an item has been received, location module 124 can determine where an item is located in area 106 by sending a location request via network 120 to the master station 125. The master station may then relay the location request to base station 112. In one embodiment, base stations 110, 112, 114 may locate item 108 by sending location request to item 108, receive response signals, and triangulate the item 108 based on the response signals. Though this enhanced, triangulation process, software defined phase array and multiple antenna elements may be used to improve the accuracy needed to determine the location of the item. Therefore, while a user 100 can receive the proximity of an item to a user device on a user device 102, the user can receive a more precise location of one or more items on a user device 102 when multiple base stations are involved. In another embodiment, user 100 may want to locate item 116 inside of Smart container 118. Upon receiving location request from base stations 110, 112, 114, Smart container 118 may query all contained Smart labels looking for item 116. When item 116 has been found, Smart container 118 may relay location information back to base stations, 110, 112, 114. Smart containers may also retain an inventory of items located within the container, thereby limiting the need to communicate directly with the items and hence extending the battery life of the items. In one embodiment, base stations 110, 112, 114 send location and other information to the master station 125. The master station 125 sends location and other information to the location module 124 through network 120. The location module 124 may process the information and send the information to user device 102.

In another embodiment, location module 124 may assist in simple organizing and sorting tasks. For instance, a user 100 may wish to sort his or her sockets in a particular order. Location module 124 may cause LED lights to flash in sequential order on the sockets, indicating to the user the particular order in which they should be sorted. Location module 124 may identify any missing sockets and notify the user 100 of the missing sockets' location. In another embodiment, location module 124 may cause sock pairs to flash at the same time, thus facilitating the identification of matching pairs. In one embodiment, the Smart labels on the sock pairs include electromagnets, thereby enabling location module 124 to activate the corresponding electromagnets in a pair of socks, causing them to automatically sort themselves. In another embodiment, a conveyor belt for a clothes dryer may read Smart labels on clothing and sort the clothing accordingly.

In one embodiment, user 100 may configure location module 124 to group items into useful categories. For instance, a user 100 might configure location module 124 to pair a phone with a particular phone charger. In one embodiment, if the user's 100 phone is packed before a trip and the corresponding charger remains next to the desk, the user may receive a notification reminding user 100 to pack the charger and notifying user 100 of the charger's location. In another embodiment, location module 124 may be configured to notify user 100 if a particular item is ever in a particular place. For example, a user 100 may wish to be notified if his or her car keys are ever accidentally thrown away. Location module 124 may periodically query the keys (with Smart label) to be sure they aren't in the trash (Smart container).

In another embodiment, item 108 has a home base where the item should reside. Location module 124 may notify user 100 if an item is not at its home base and inform the user 100 of the item's current location. In one embodiment, a base station 110 may be used to determine information about an item 108. For example, item 108 may be held next to base station 110, causing location module to provide the user 100 with information about the item such as the item's home base, usage details, and sorting details (e.g. location of the item's pair, the category to which the item belongs).

In another embodiment, base stations 110, 112, 114 need not be used to locate an item 108. Instead, location module 124 may rely on locating technologies such as Global Positioning System (GPS) and Global System for Mobile Communications (GSM) to locate item 108. In some embodiments, user device 102 may serve as an additional base station or may directly locate item 108 by utilizing locating technologies like RFID.

In one embodiment, item management may include one or more of the base stations 110, 112, 114 working together to produce sound, light, and/or other signals and notifications that leads user 100 to a search target item 108. For example, base stations 110, 112, 114 or a sensor may project one or more LED lights, laser pointer(s), or other notifications onto a wall or surface close to a desired search object such as item 108. By doing so, “Breadcrumb” or path type notifications can indicate direction and “roadmap” user 100 to one or more desired items. Additionally, a similar lighting language may be used for indicating things such as locations or distances of items. In another example, the endpoints may be simplified by using sound notifications produced by base stations 110, 112, 114, and/or user device 102. As the user moves closer to a search object, the user device 102 and/or base stations 110, 112, 114 may make louder or softer noises. Through this way, audible language, like visual light language, may be used to indicate the location and/or distance of one or more items.

In an embodiment, a user 100 sends a mapping request to an information module 121 on server 122 of server computing system 126 via user device 102. The information module 121 may further comprise a location module 124, a mapping module 130, a security module 131, and/or a property module 132 (as detailed in FIG. 1B). Therefore, a user 100 sends a mapping request to mapping module 130 on server 122 of server computing system 126 via user device 102. Base stations 110, 112, 114, may be devices capable of mapping area 106. For example, base stations 110, 112, 114 may be placed in one room of a house, or commercial or industrial building, where they are directed to map the room or Surrounding area. Mapping-enabled base stations 110, 112, 114, may employ sound systems (e.g. Sonar, radar), optical systems (e.g. lasers, cameras), and the like to measure a portion of an area. The mapping module 130 receives measurement data from mapping-enabled base stations 110, 112, 114 via the master station 120. Using the measurement data, the mapping module 130 generates a multi-dimensional map of the room and floor plan. In some embodiments, other system components such as an aerial, aquatic, and/or ground-moving drones may be used to create multi-dimensional maps and floor plans of areas. In other embodiments, multi-dimensional maps and floor plans created independently may be uploaded to and utilized by the mapping module 130.

In one embodiment, the multi-dimensional map may be used to accurately describe the location of items. For example, upon receiving location information for item 108 from base stations 110, 112, 114, the location module 124 may determine, based on the triangulated location and a multi-dimensional map of the area, that item 108 is on the bookshelf in the south-east corner of area 106. The user 100 would have the option to view this multi-dimensional map on the user's device 102. In another embodiment, mapping-enabled base stations 110, 112, 114 are capable of tracking an items location when moved around the room and notifying user 100 of movement. The base stations 110, 112, 114 may periodically inventory all items (e.g. 116, 108) in area 106. For example, base stations 110, 112, 114 located inside a refrigerator may periodically inventory refrigerated items and notify user 100 when an item needs to be restocked or replaced. In another embodiment, the user 100 may authorize the location module 124 to place an order for an item in response to the item needing to be restocked or replaced. The location module 124 may automatically generate shopping lists based on inventories and user-configurable quantity thresholds. The location module 124 may automatically generate a list of items associated with a task the user 100 is about to perform or an activity the user is about to engage based upon item usage patterns. Such lists may include kitting lists to prepare for a camping trip, shopping lists prior to heading out to a store, lists detailing common items needed to have before venturing out on a boating excursion such as sunscreen or fishing rods, lists detailing common items or tasks needed to have completed before leaving on vacation such as locking the front door, lists detailing common items needed to have before going to school such as pencils and a lunch, lists detailing common items needed to have before going to work, and the like. The location module 124 may also track normal usage patterns of item 108 and notify user 100 when abnormal patterns occur. In doing so, the location module 124 may take inventory of multiple items simultaneously to determine when items can be discounted, removed, donated, or scrapped due to diminished quality. In another embodiment, a user 100 may determine allowable boundaries for an item 108. When item 108 is taken outside of its allowable boundary, user 100 may be notified.

In an embodiment, geolocation of items may also be obtained by using other technologies such as sound, ultrasonic, light, variable signage, or others. For example, as a user moves closer or farther from one or more items, sounds, signals, lights or other notifications change to indicate the relative proximity of the user to the items as a result of the system's fast find feature. In an embodiment, temperatures may be updated to reflect the relative proximity of the user to the item. Such temperatures may include a hot, warm, or cold temperature. For example, as the user searches and moves closer to a desired item, a temperature may increase causing the user to sense an elevated temperature as the user progressively gets closer to the desired item. In another example, as the user searches and moves farther from a desired item, a temperature may decrease causing the user to sense a lower temperature as the user progressively gets farther from the desired item. How temperatures correspond to a user's relative distance to a desired item may be pre-set, meaning that a user may elect to feel a colder temperature as the user moves closer to a desired item or a warmer temperature as the user moves farther from a desired item. Also, a warm temperature may be felt by the user if the user progressively gets closer or farther from a desired search object.

In another embodiment, vibrations may be used to communicate the location and/or distances of items to a user. For example, the vibrations of a user device 102 may intensify if the user proceeds to get closer to an item 108. In another example, a user device 102 may vibrate a set amount of times over a specified duration that would allow the user to understand the approximate location of an item 108. By vibrating four times over the course of four seconds, for instance, a user may understand this to mean that the item would be located somewhere within a fourth room of a house or in a fourth bay of an industrial multi-loading dock area.

In another embodiment, individual item location notification(s) may be provided to a user. For example, an item from its Smart label or a user device 102 may emit beeping patterns to notify the user what the user might be forgetting. In another example, an item from its Smart label or user device 102 may produce beeps or annunciate in a pattern to help identify a location of an item 108. By beeping three times, for instance, a user may understand this to mean that the item would be located somewhere within a third floor area of a house. In one embodiment, audible symbology may assist in the location or identification of an item. For example, the audible sound produced such as keys jingling, phone ringing, and so on may be used to notify the user that the user does not currently have keys or a phone in the user's possession. Furthermore, unique automobile sounds may be emitted from the item's Smart label depending on the automobile type associated with the item. For instance, a Smart label on a Nissan® key may produce a different sound of a Nissan® car starting up compared to a Smart label on a Mercedes Benz® electronic key that would produce the sound of a Mercedes Benz® starting up. In another embodiment, the sound used to notify the user may be other car starting up noises not specific to the car key brand or may even be the sound of an automobile horn honking.

In an embodiment, the location module 124 may use predictive algorithms to aid in the automatic replenishment of items. This may be accomplished by re-ordering items based upon their consumption and corresponding location, such as within a Smart container 118. In another embodiment, the location module 124 may notify the user if an item is placed within a wrong container such as a recycling container versus a trash can. In an embodiment, an audible indication may be produced by either the Smart label of an item 116 or a Smart/Green container if the item 116 is placed within Smart/Green container. For example, if keys or some other item is incorrectly discarded, then the user may be notified of the erroneous discard through sound. In another example, an alarm may sound when a battery or some other hazardous item is placed in the Smart/Green container. Alternatively, a Smart/Green container may emit LED or laser lights of one or more colors to notify the user that an item has been placed within a Smart container when it does not belong there. In another example, a Smart/Green container may vibrate until the item is removed from its contents.

In some embodiments, Smart containers may also aid in the entry and exit detection of items. The detection of items entering or exiting any Smart container may be based upon image recognition (photo recognition), product label, RFID, universal product code (UPC), weight, density, or others. For example, a Smart container 118 may determine that an item 116 has been located inside of its area by scanning the item's Smart label or UPC either before the item 116 formally enters the Smart container 118 or once the item 116 has been laid to rest within the Smart container 118. In another embodiment, the contents of a Smart container 118 may be determined by having the Smart container 118 scan itself. A Smart container 118 may disclose the weight and/or density of its contents at any given time to a user device 102. Additional sensors may be used with the Smart container to determine the moisture, temperature, pH, or other characteristics of the contents within the Smart container. For example, the Smart container may scan its contents to determine either the respective density and pH of the individual items or the density and pH of the combined contents. If the overall density exceeds a certain amount, then the location module 124 may notify the user 100 not to place any additional items within the Smart container. In another example, if the Smart container determines that the pH of the combined contents is too acidic, resulting in a low pH, then the location module 124 may notify the user 100 to add more neutral or basic items to the Smart container to balance out the pH. In an embodiment, either the Smart container or a user device could notify the user 100 if a specific characteristic threshold within the Smart container is met through notifications such as sound, ultrasonic, light, variable signage, or others.

In an embodiment, Smart containers need not be the size of waste baskets or large industrial trash holders; Smart containers may also be size specific. For example, Smart containers may be used for package content validation. Smart containers may determine the weight, density, moisture, pH, size, and/or other characteristics of one or more packages at any given time. By having one or more Smart containers determine these factors, a user can track the frequency of use of any item within any Smart container that is connected to a network. This information may be used to trigger automated ordering of replacement items at the discretion of the user.

In another embodiment, drone based Smart containers may be used. The drone based Smart containers may be, for example, unmanned aerial vehicles, unmanned ground based vehicles, or unmanned fluid based vehicles. Like other Smart containers, drones can identify, count, and classify items by using image recognition or by scanning RFID, UPC, or other labels. In some embodiments, drones may be used both indoors or outdoors. For example, drones may be unmanned aerial vehicles, unmanned ground based vehicles, or unmanned fluid based vehicles. Drones may travel over specific patterns based upon requirements or can respond by changing travel patterns and actions based upon inputs from other drones, Smart containers, base stations, sensors, and camera inputs. Drones can return to a fixed charging station to dock and recharge. The Smart drone containers may include one or more of the following functionality: automatic mapping and problem finding (e.g., aerial and fluid based such as drain clog); fixed path on map for patrolling that is set up by the user, drone can monitoring and following of targets; target identification by infrared sensor, sound monitoring or detecting targets using a camera; presence sensing of targets, using motion detectors, within an area then the drone can go to the area that the sensor detected motion, audio detection, using audio detectors, to detect noise, breaking glass etc. and dispatch drone. The Smart drones may also include other types of sensors including one or more of the following: temperature detectors can detect changes in surfaces and dispatch drones to investigate; olfactory sensors can detect smells; pressure, temperature, humidity sensors that can dispatch drone; and leak detectors can dispatch drone and direct them to areas. Battery and line powered sensors may be located throughout the area being monitored either in fixed locations known to the system or mobile sensors may be deployed whose locations are determined by the system. A grid of Smart Containers, one per room for instance, may be deployed to determine what location within a building an event is occurring. Once an event occurs and the location is known a drone may be dispatched to the location of that Smart Container. In this scenario, Smart Tags may be attached to items being monitored. These Smart Tags communicate directly to the Smart Containers. The Smart Containers then can use a means such as the received signal strength value of the last packet of wireless data received from the Smart Tag to determine the distance between the Smart Tag and Smart Container. The Smart Container then compares that to the signal levels defined for its size as a Smart Container with larger container sizes allowing lower RSSI values to be considered within that container. Knowledge of which Smart Container has the target of interest allow dispatching the drone to a smaller area to begin its search.

FIG. 1B illustrates a second example tracking and management system specifically using drones in accordance with various embodiments of the present disclosure. In one embodiment, a user 100 sends a request to an information module 121 (as previously described above) on server 122 of server computing system 126 via user device 102. The information module 121 may further comprise a location module 124, a mapping module 130, a security module 131, and/or a property module 132. Computing systems described herein (e.g. 126) are each capable of communicating with one another via network 120. In an embodiment, drones 140, 141, 142 may be deployed to create 2D and/or 3D maps or floorplans of areas as a result of a user request to mapping module 130. It should be reminded that one or more drones may be used to complete a task at any given time and should not be limited to only three drones in other embodiments. For example, one or more unmanned aerial vehicles could take measurements of a region by flying overhead to construct a 3D representation of an area. Similarly, one or more unmanned ground based vehicles could also take mapping data from a ground perspective or supplement data not able to be captured by the unmanned aerial vehicle. An example of this would be having one or more unmanned ground based vehicles map out tight spaces in a cave, where unmanned aerial vehicles may have difficulty maneuvering. Additionally, one or more unmanned fluid based vehicles may be used to map the depth and record the characteristics of oceans, seas ponds, rivers, swimming pools, or alike. In another embodiment, fluid based vehicles may be used to map the dimensions of a faucet pipe or one or more bathroom pipes to determine the location of a blockage and/or abnormality within the one or more pipes. Location, sensor, and image data captured by the one or more drones can be sent to a data storage location (such as the cloud) for data processing, to the user directly via a mobile app in a user device by means of mapping module 130 and network 120, or can be sent to the police or other monitoring entity through security module 131 and network 120. By communicating with fixed and non-fixed items and assets to provide deterrence, alarms, and escalated notifications, drones may be used for security and safety monitoring through their automated mapping.

In an embodiment, drones 140, 141, 142 may be used to determine more precise locations of items by using received signal strength indicator (RSSI) or camera images alone or in cooperation with one or more base stations and/or other drones. Drones can use GPS signals along with radio frequency (RF) proximity measurement and/or triangulation to better determine the locations of items. Additionally, drones can use one or more laser sensors to measure the distances between the drone and one or more items of interest such as people, animals, or things. This may be done while the one or more drones are mapping areas or re-mapping areas to account for updates. In some embodiments, drones can have multiple sensors in addition to a camera or the laser sensor such as an infrared (IR) imager, temperature, humidity, atmospheric pressure, and alike. For example, while at night, drones may be able to use their infrared sensor to identify a human moving through a mapped area based on the heat the human is giving off. The drone may then track and record a full motion video of the human to send to security module 132, which may then send the information to the police for added security measures. In another embodiment, place shifting a camera alone or place shifting other sensor may be pursued between system components. For example, by having a stationary Smart container identify through its camera a moving item with or without a Smart label within an area, place shifting of the camera between the Smart container and mobile system component such as a drone may occur. As a result, the one or more unmanned aerial vehicles, which periodically fly a route on a schedule or are triggered by an event such as the detection of a movement in a mapped area, may then begin to record the moving item with their camera. By doing so, system components are able to work together to extend the range of the stationary Smart container's RF range and visual range of the camera by the distance that the one or more drones can travel.

In an embodiment, an item 108 may approach a residence, commercial building or other site within an area 106. Based on the item's motion or a push of a button, for example an individual pushing a doorbell, one or more drones 140, 141, 142 and/or one or more other vehicles may depart from their respective charging dock 145, 146, 147 and record full motion video or take photos in the location where the motion or button push was detected. The information obtained may then be transmitted to a user device 102, a security module 131 within server 122, cloud, or computer system 126. Based on the motion source, the moving item may be tagged and followed for some distance by one or more drones and/or one or more other vehicles to gather additional information from the moving item. If the moving item is identified as a human, such additional information may include higher quality views of the moving human and/or the moving human's initial mode of transit such as images of the human's automobile, truck, motorcycle, or boat. Further distinguishing characteristics may be recorded such as a vehicle's license plate number, the color and dimensions of the structure used for transportation, and other information. If the moving item is identified as an animal, such additional information may include higher quality views of the moving animal and its terminal location if located within a fixed area. The terminal location may be a hole in a tree, a hole in the ground, or other location.

In another embodiment, the information module 121 may be used to identify whether family members or people arrive safely into their residence. This may be done by triggering an automatic departure of one or more drones 140, 141, 142 and/or one or more other vehicles upon sensing family members entering an area and then filming the last five minutes of a family member driving or walking before entering a residence safely. The one or more drones 140, 141, 142 and/or one or more other vehicles may dispatch to specific areas within a residence, yard, commercial building, or site based on detected motion from distributed sensors. These sensors can be networked to allow the one or more drones and/or one or more other vehicles to be used across a given site, enabling the system components to be used together in a networked group if needed for larger areas. The amount of equipment needed to secure a site is minimized through the use of one or more drones 140, 141, 142 and/or one or more other vehicles while greatly improving the video and photo quality when compared to fixed camera systems. The system can provide activity report frequency and can exhibit variable behavior based on time of day or night. Furthermore, the system components may be integrated with Enhanced 911 if desired based on certain emergency codes. Through these means, a user 100 is able to benefit from the way a camera or set of cameras is able to react in a variable way to visitors, intruders, and other threats.

In an embodiment, one or more drones 140, 141, 142 and/or the one or more other vehicles come equipped with their own power source, enabling them to be deployed multiple times without recharging, thereby rendering the system tamper proof In some embodiments, once a given event is recorded, the one or more drones and/or the one or more other vehicles will return automatically to their respective charging stations 145, 146, 147 or a group charging station to recharge. Either type of charging stations would enable the one or more drones and/or the one or more other vehicles to dock and undock from the charging station automatically. Battery condition can be reported from each of the one or more drones and/or one or more other vehicles to the property module 132. Additionally, the battery charge state and number of charge cycles may be recorded and used to predict the overall battery life and required battery replacement estimate. This information may be displayed on a user device 102 or on the one or more drones 140, 141, 142 and/or the one or more other vehicles themselves.

In an embodiment, one or more Smart tags may be used on an item 108 or on an item 116. For example, a Smart tag such as a level sensor may be placed on items like laundry detergent, a Windex® bottle, and/or others. The level sensor would determine the level of fluid within the bottle, which may correspond to when to reorder the item. In another embodiment, one or more level sensors may be placed on the same item. These sensors may establish thresholds such as when the container's contents are running low, when the amount of contents remaining triggers a suggestion to reorder the item or automatically reorders it, or when the item is empty and should be discarded. In an embodiment, the Smart tag may be disposable and may not consist of a battery. In another embodiment, the Smart tag may not be disposable and have a battery or other means of powering the Smart tag such as solar power. For example, one battery option may consist of two or more reservoirs that combine chemicals into a common orifice to power the Smart tag or other system component. This battery set up would allow a smaller form factor and result in a longer battery life by doing time release or on demand operation of a power source.

In another embodiment, other Smart tags may be adhered or built in to other items. For example, Smart tags may be used in bars, taverns, restaurants, homes, or other areas that have food and beverages in order to facilitate an enhanced service experience. A user would be able to determine how much drinking liquid would be present in a glass at any given time through the use of one or more Smart tags. By having property module 132 automatically determine the level of beverages through the data provided by the use of one or more Smart tags, revenue and customer satisfaction may be increase by directing restaurant and kitchen staff to provide an additional drink to customers in a timely manner. In an embodiment, the property module 132 may automatically track the number of drinks provided to a specific customer, regardless of whether the customer moves around within the area's boundaries or is stationary. By doing so, the potential for over indulgence may be monitored. In embodiments, Smart tags need not be conspicuous to perform their intended functions. An example of this would be integrating Smart tags into drinking devices such as a straw or liquid container.

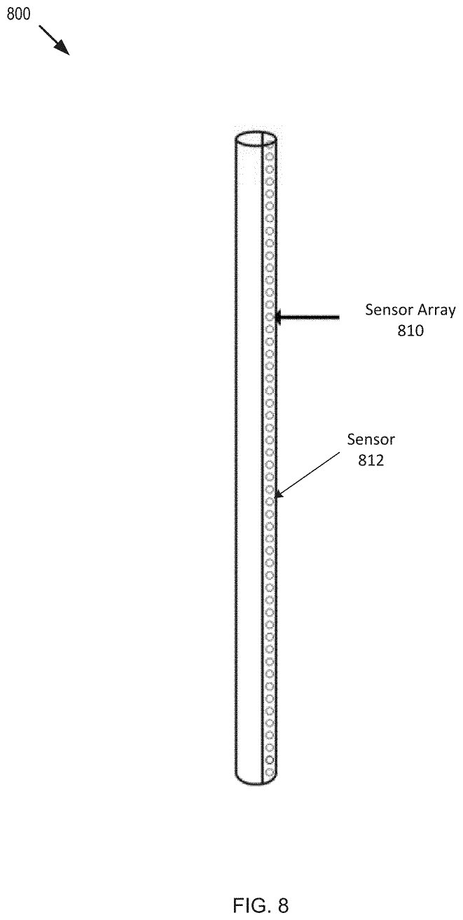

FIG. 8 illustrates one embodiment of a smart straw. In this embodiment, smart straw 800 includes a sensor array 810 sensor disposed along its length. The sensor array 810 may include one or more individual sensors 812. The smart straw, located partially in the beverage, could determine both the amount of liquid as well as the temperature of the liquid within the glass. This may be accomplished while an individual is using the smart straw itself to drink the contents of the glass. By being notified by the property module 132 of the amount of liquid and of the temperature of the liquid within a glass, a user may elect to remove the glass from an area or refill the glass if the contents are empty. A user may also decide whether or not to add more ice to the glass if the temperature of the liquid reaches a certain value. Conversely, a user may decide whether or not to offer an additional heated beverage if the temperature of the liquid in a container cools. In an embodiment, the property module may automatically track the amount of liquid consumed by a specific customer by receiving information from one or more smart straws. By doing so, the potential for over indulgence may be monitored. In embodiments, smart drinking holders could have Smart tags intrinsic to the holders themselves, thereby making them able to determine the level and temperature of the liquid. Also, Smart tags may be used with ice chests, coolers, ovens, or alike to provide the property module with temperatures of an area within a boundary. By monitoring the temperature of an area within a cooler, there can be added assurance that certain foods never exceeded a specific temperature and are thereby safe to serve to consumers. The smart straw may be equipped with an RF communication device such as BLE (Bluetooth Low Energy) to monitor temperature and level of fluids in a cup. The sensor array 810 may include one or more of the following types of sensors: a moisture sensor, a light sensor, a turbidity meter, a temperature sensor, a pressure sensor, a resistance and measurement sensor, a float position sensor, a liquid level sensor, an image sensor (e.g., camera). In some embodiments, the smart straw may also include a rechargeable battery and electronic components integrated into the straw through use two concentric closed cylinders. Electronics including battery, CPU, memory, RF radios electronics, antenna and sensor interface circuitry may be located on flexible PCB within the two concentric cylinders.

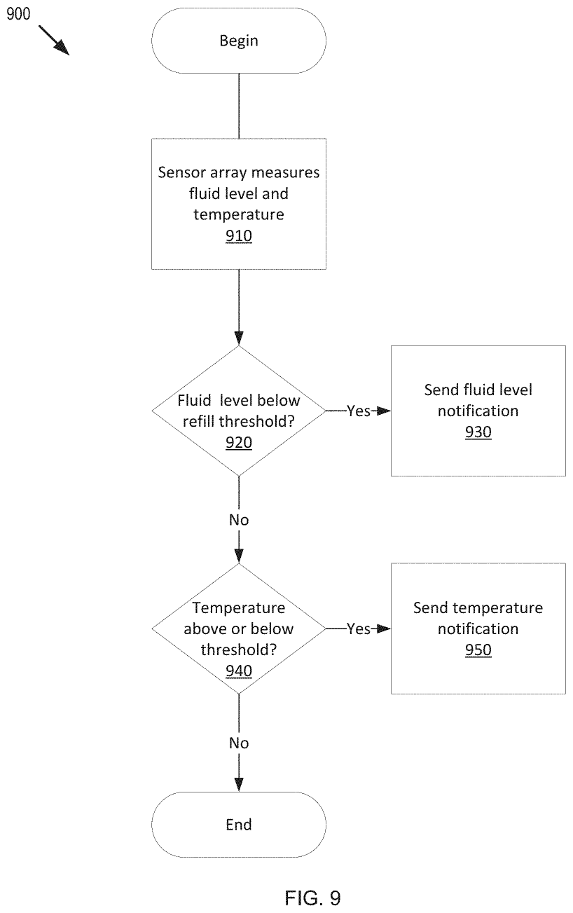

FIG. 9 is a method of using a Smart straw. The method 900 is performed by processing logic that comprises hardware (e.g., circuitry, dedicated logic, programmable logic, micro code, etc.), software (e.g., instructions run on a processing device to perform hardware simulation), or a combination thereof. In one embodiment, locating module may perform method 900. In another embodiment, other components of the devices illustrated in FIG. 1 perform some or all of the operations. Method 900 may be performed in any order so as to fit the needs of the specific location to be accomplished.

At phase 910, the sensor array 810 measure a fluid level and temperature of a liquid in a container. At phase 920, processing logic determines whether the fluid level is below a refill threshold 920. At phase 920, in response to determining that the fluid level is below the refill threshold, processing logic sends a fluid level notification to user. At phase 940, if the fluid level is below the refill threshold, the processing logic determines whether the temperature is above or below a threshold. At phase 950, if the processing logic determines that the temperature is above or below a temperature threshold, the processing logic sends a temperature notification to the user.

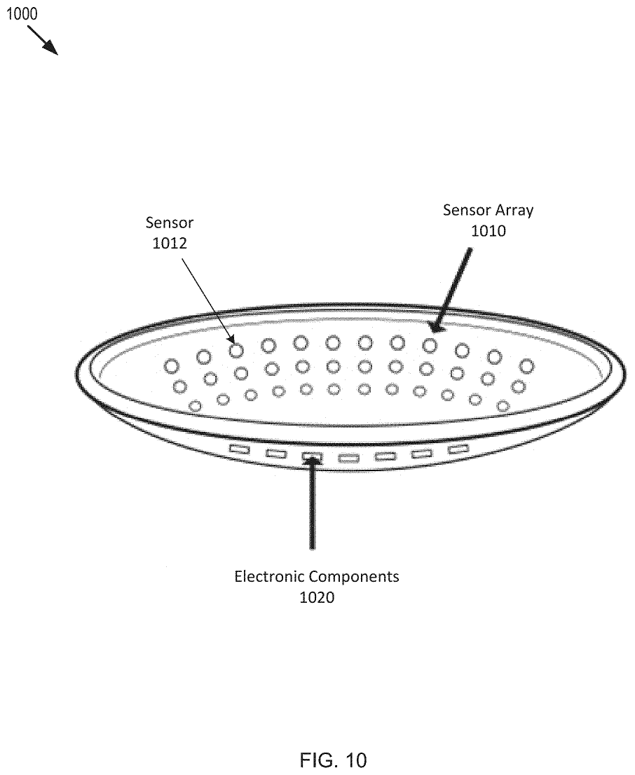

FIG. 10 illustrates one embodiment of a smart plate. In one embodiment, a smart plate 1000 may use a sensor array 1010 (i.e., Smart tags) to notify a user of the weight of the contents on the smart plate 1000. The sensor array 1010 may include one or more individual sensors 1012. If the weight determined equals the weight of the plate 1000 with little to no contents on it or if the weight has not changed significantly over a period of time, then this may serve as an indication to the user that the individual eating from the plate 1000 has finished. The user may then have the option to ask to remove the plate 1000 and inquire if the individual would want to order anything else, resulting in an enhanced serving experience through the user's attentiveness. In another embodiment, beverage coasters with one or more Smart tags may be used in a similar manner to notify the user if one or more glasses are either empty or if the individual hasn't drunk from the glass in a while. In one embodiment, electronic components 1020 (e.g., battery, CPU, memory, RF radios electronics, antenna and sensor interface circuitry) may be integrated into the bottom of the plate 1000.

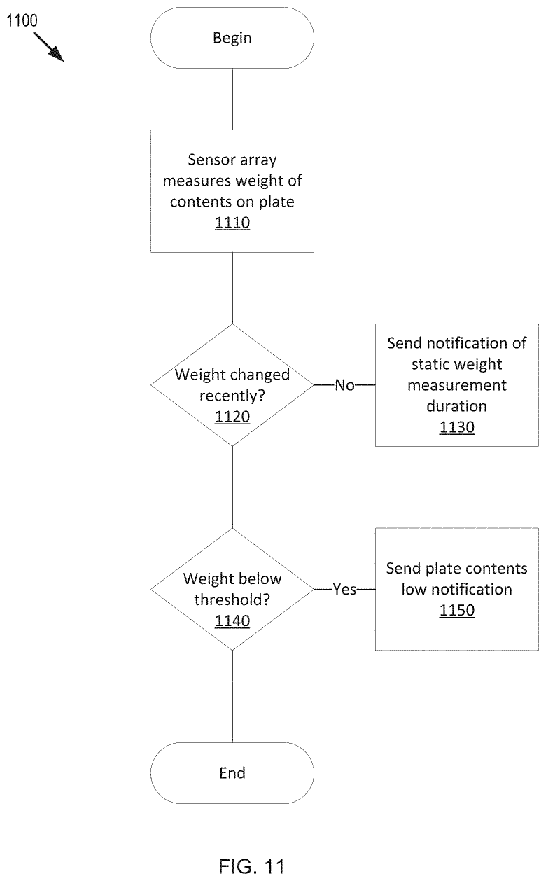

FIG. 11 is a flow diagram of a method 1100 of using a Smart plate. The method 1100 is performed by processing logic that comprises hardware (e.g., circuitry, dedicated logic, programmable logic, micro code, etc.), software (e.g., instructions run on a processing device to perform hardware simulation), or a combination thereof. In one embodiment, locating module may perform method 1100. In another embodiment, other components of the devices illustrated in FIG. 1 perform some or all of the operations. Method 1100 may be performed in any order so as to fit the needs of the specific location to be accomplished.

At phase 1110, a sensor array 1010 measures weight of contents on a Smart plate 1000. At phase 1120, processing logic determines whether the measure weight on the Smart plate 1000 has recently changes (e.g., within a threshold amount of time). If the weight has not changes, at phase 1130 the processing logic sends a notification of static weight measurement duration. At phase 1140, the processing logic determines whether the measured weight has dropped below a threshold. At phase 1150, in response to the weight dropping below the threshold, the processing logic sends a plate contents low notification 1150 to a user.

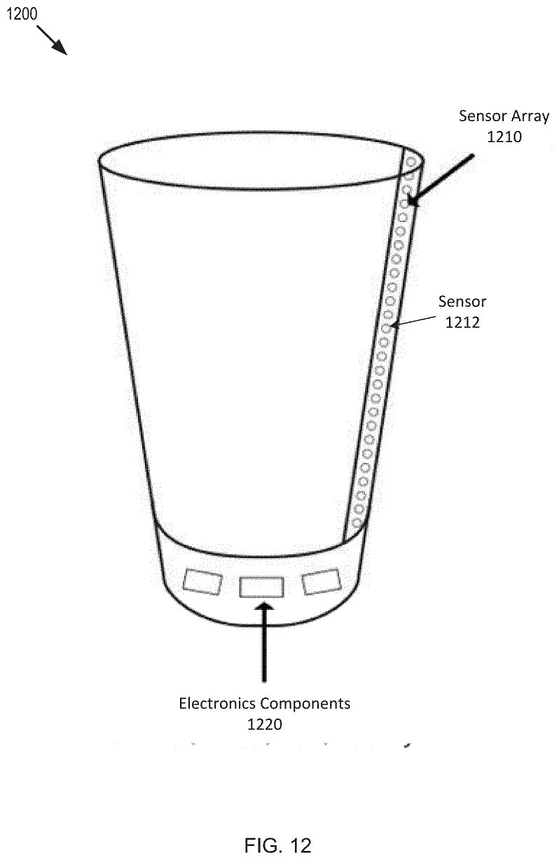

FIG. 12 illustrates one embodiment of a smart liquid container (e.g., a glass or bottle). In some embodiments, a smart glass 1200 may include a sensor array 1210 and electronics components 1220. The sensor array 1210 may include one or more individual sensors 1212. In some embodiments, coasters and glasses may have Smart tags on or intrinsic to them and work together to determine the weight of the liquid in the glass. By knowing the location of one or more smart glasses 1200, with intrinsic weights without liquid in them, through their Smart labels, the smart coaster could then use this information upon determining which smart glass 1200 is located on top of it to calculate the weight differential to arrive at the fluid weight and or volume. Other calculation methods may be pursued for the user to receive either the fluid weight or fluid volume in any given smart glass 1200. In an embodiment, the property module may automatically track the amount of liquid consumed by a specific customer by receiving information from one or more smart coasters. By doing so, the potential for over indulgence may be monitored. The smart plate 1000 or smart glass 1200 may include the same components as noted above in regards to the smart straw 800. In one embodiment, electronics components 1220 (e.g., battery, CPU, memory, RF radios electronics, antenna and sensor interface circuitry) may be integrated into the bottom of the smart glass 1220. In some embodiments, optical sensors may be used to determine the presence and amount of food on the plate or monitor light levels, moisture detectors can help determine water content of the food, temperature sensors can monitor the temperature of plate, and image sensors can monitor food content on the plate.

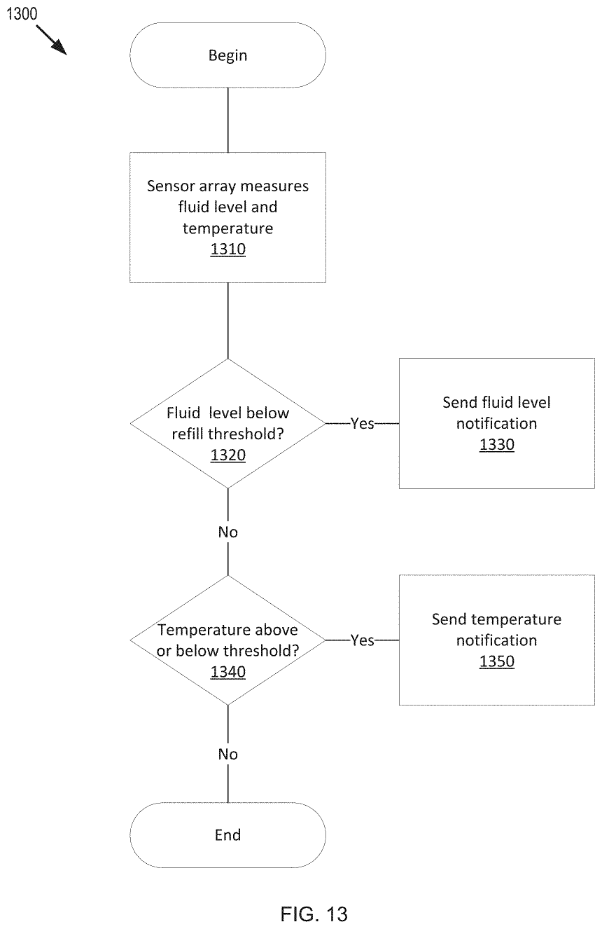

FIG. 13 is a flow diagram of a method 1300 of using a Smart liquid container. The method 1300 is performed by processing logic that comprises hardware (e.g., circuitry, dedicated logic, programmable logic, micro code, etc.), software (e.g., instructions run on a processing device to perform hardware simulation), or a combination thereof. In one embodiment, locating module may perform method 1300. In another embodiment, other components of the devices illustrated in FIG. 1 perform some or all of the operations. Method 1300 may be performed in any order so as to fit the needs of the specific location to be accomplished.

At phase 1310, a sensor array 1210 of the smart glass 1200 measure a fluid level and a temperature of the fluid in the smart glass 1200. At phase 1320, processing logic determines whether a fluid level below a refill threshold. If the fluid level falls below the refill threshold, at phase 1330 processing logic sends a fluid level notification to a user. At phase 1340, the processing logic determines whether the temperature of the fluid in the smart glass 1200 is above or below a threshold. In response to determining that the temperature is above or below the threshold, at phase 1350, the processing logic sends a temperature notification 1350 to a user.

In another embodiment, service trays may use Smart tags and Smart labels to provide a user with information concerning the weight of the contents on a smart tray through a property module 132 as well as the location of one or more smart trays through a location module 124. For example, by tracking the movement of the Smart label associated with the smart tray, the location module may determine the frequency of tray use in a given area. The location module may generate lists based on which customers required the most tray service while taking into consideration the amount of food or beverages ordered by recording the weight of the purchases through the tray's one or more Smart tags. In another example, smart table surfaces with one or more Smart tags and/or labels may also exist with smart utensils with one or more Smart tags and/or labels. By tracking the movement of the Smart labels associated with the smart utensils, the location module may determine whether utensils have been moved and require replacing (such as falling to the ground or angled onto a once full plate) or should be left alone. In an embodiment, smart table surfaces act as communication interfaces between system components such as Smart labels, Smart tags, base stations, Smart containers, and/or drones for identifying, grouping, pairing, and tracking items.

In another embodiment, clothing items may use one or more Smart tags. For example, smart buttons with an integrated sensor in the button may be used to notify a user whether a shirt button has or has not been successfully buttoned. In another embodiment, a smart zipper with an integrated sensor in the zipper pull may be used to notify a user whether a jacket or other garment has or has not been successfully zippered to a given length as judged by the user or based on the user's past conduct.

In another embodiment, a sunglass case may use one or more integrated sensors to notify a user if the sunglass case is open, closed, and has contents (such as sunglasses) or is empty. Integrated sensors may also exist in sunglass lenses or frame to monitor the adjustment of the lenses response to the ambient ultraviolet (UV) light by means of either darkening or lightening. The integrated sensors may also be used to monitor the ambient temperature and humidity and trigger the sunglasses to not fog up. Presence sensors may also be used allow a user device to detect the location of the sunglasses. In another embodiment, smart eyeglasses may also have UV, temperature, and/or humidity sensors to perform comparable functionality as do the sunglasses. Integrated sensors that monitor the ambient temperature and humidity may also be used in conjunction with watches, camera lenses, and/or phone screens to trigger corrective actions to prevent the items from fogging up, for example. In an embodiment, shoelaces may use integrated sensor in the laces to notify a user whether shoes have or have not been successfully tied. In another embodiment, tripods may use integrated sensors to provide the user with the proper leg distances to provide a level surface in a specific location. Placemats may also use integrated sensors to serve comparable functions as the smart trays as mentioned above.

In an embodiment, as mentioned above, system components such as Smart labels, Smart tags, base stations, Smart containers, and/or drones may indicate location or direction of items by shining a laser, emitting light, emitting audio sounds, and/or vibrating or using other means to indicate direction of items to be found.

In an embodiment, system components such as Smart labels, Smart tags, base stations, Smart containers, and/or drones may have movement controlled energy functionality associated with them. For example, base stations may only active and use their battery or solar power based on when an item is moved. Detection of movement may be accomplished through the use of intrinsic accelerometers, ball bearings, or other means within the equipment. In some embodiments, cameras may be used to register motion within an area and upon registering a motion, trigger the one or more system components to “wake-up”. In another embodiment, the system components may wake-up based on facial recognition of a user entering an area or from registering sounds of a user such as the user's footsteps in an area. In an embodiment, the system components themselves may only wake up when they are physically moved, thereby conserving battery use.

In one embodiment, one or more smart charging stations may be used to ensure system components such as Smart labels, Smart tags, base stations, Smart containers, and/or drones have a sufficient amount of power to perform tasks. The smart charging stations, for example charging docks 145, 146, 147, may allow automated charging and/or guidance of one or more items to be charged via sensor, magnet, or other means and can also enable automatic docking and identification. In an embodiment, a single camera or set of sensors may fly or roam an indoor or outdoor pattern for security, safety, and other purposes. For example, one or more drones 140, 141, 142 may be used to pick up one or more items, move the items around, and place the items in one or more locations such as a charging station. This may be accomplished through using electromagnetic pick up mechanisms or other pick up mechanisms such as using one or more mechanical arms. In an embodiment, the items may be placed in a charging station area, where the items are able to be attached to the charging station through electromagnetic forces or other means for attachment to the charging station. Additionally, system components such as Smart labels, Smart tags, base stations, Smart containers, and/or drones can provide charging functions to each other and to endpoints or other system components.

In embodiments, multiple sensors may be used to facilitate data acquisition and synthesis from system components. For example, multiple devices types (LED, UPC, quick response (QR) code, RFID, Bluetooth® low energy (BLE), GPS, or other sensors or device types) can be used to enable synthesized actionable data from cross platforms and applications.

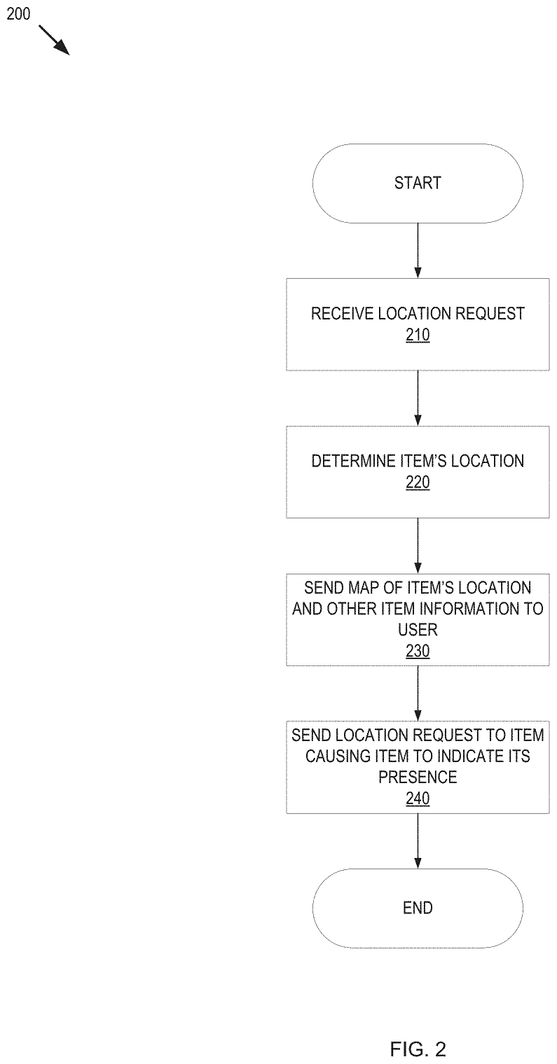

FIG. 2 is a flow diagram of a method for locating an item in accordance with some embodiments. The method 200 is performed by processing logic that comprises hardware (e.g., circuitry, dedicated logic, programmable logic, micro code, etc.), software (e.g., instructions run on a processing device to perform hardware simulation), or a combination thereof. In one embodiment, locating module may perform method 200. In another embodiment, other components of the devices illustrated in FIG. 1 perform some or all of the operations. Method 200 may be performed in any order so as to fit the needs of the specific location to be accomplished.

At phase 210, location module receives a location request from a user. In one embodiment, processing logic then determines the location (phase 220) of the requested item using locating technologies described above. In one embodiment, base stations triangulate the item's Smart label. It should be noted that triangulation for locating items may be performed using multiple base stations to determine an item's location in multiple dimensions. In some embodiments, the user is not located within range of base stations. For example, a user may be at work and realize that he or she does not have his or her wallet. Processing logic may determine the location of the wallet at home, using base stations to triangulate the wallet's signal, while the user remains at work. At phase 230, processing logic sends a map of the items surrounding location and additional item information (e.g. pattern data, location of matching pairs, category data) to the user. In one embodiment, the location module may also send other information pertaining to the location of the requested item. Such information may include a container in which the requested item currently resides, a room in which the requested item currently resides, a list of other items also residing in the container and/or room in which the requested item resides, a category in which the item belongs, and a list of other items in the same or similar categories and their locations. At phase 240, processing logic may send the location request to the item causing the item to indicate itself via its Smart label.

In one embodiment, images such as photographs may be used to augment the locating of items. For example, during a system installation, pictures can be taken of a room or an area or areas of a building in which items may be located, and then the location of the various items whose image is acquired can be plotted. Alternatively, one or more of base stations may include cameras (e.g., visible, infrared, etc.) that can take still images or video images of area and transmit the images to server to indicate the location of the items to be found.

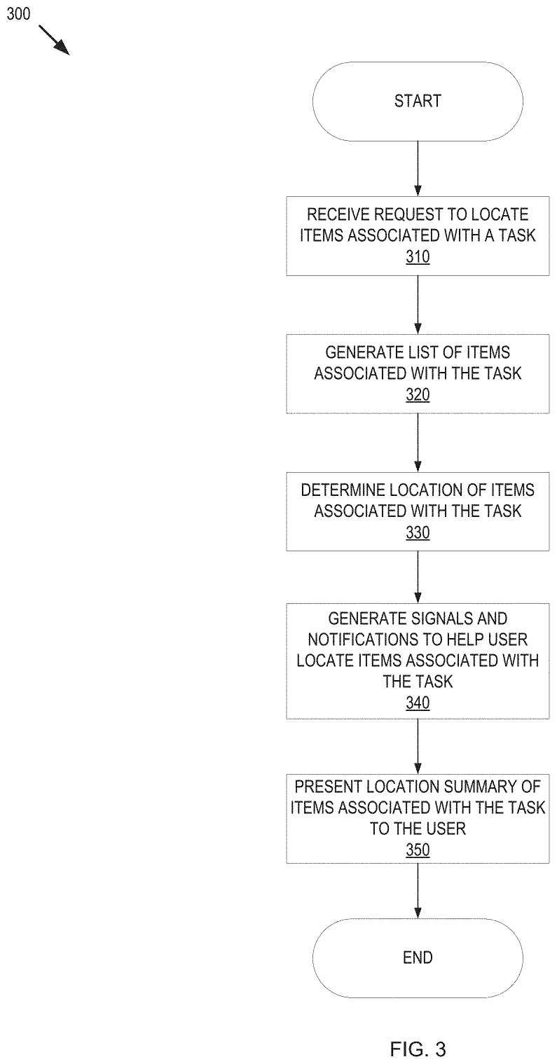

FIG. 3 is a flow diagram of a method 300 of generating a list and indicating the location of items associated with the list. At phase 310, the location module receives a request from a user to locate all items associated with a task. In one embodiment, the request from the user may be the user manually selecting a task being performed from a user interface that often presents frequently used tasks. The user interface may be in the form of an electronic tablet, iPad, iPod, mobile phone, enhanced electronic glasses or other device. In another embodiment, the location module may determine the task being performed in response to the user's recent or past activities. For example, upon a user moving a socket set, the location module may deduce that based on a recent purchase of motor oil for an owned vehicle, the required socket or wrench size to perform an oil change may be automatically identified. In another example, once user moves an item such as dog leash, the location module may automatically identify the location of the dog and/or other dog walking equipment. At phase 320, the location module generates a list of items associated with the task based on the properties of the items. At phase 330, the location module determines the location of the items from the list of items associated with the task. The location module may determine the location of the items using the method described above and summarized in FIG. 2. At phase 340, the location module helps the user locate the items within the list through the use of sound, ultrasonic, light, variable signage, vibration, and/or other signals and notifications to lead user 100 to the search target item as previously mentioned. In an embodiment, the item can identify itself through the use of Smart labels and/or a LED light. In another embodiment, the user can select through the user interface to activate a camera, which will provide a live feed of an area and zoom in to the location of the item, so the user can determine its location. At phase 350, the location module presents to the user on the user device a summary of all the item locations associated with the task.

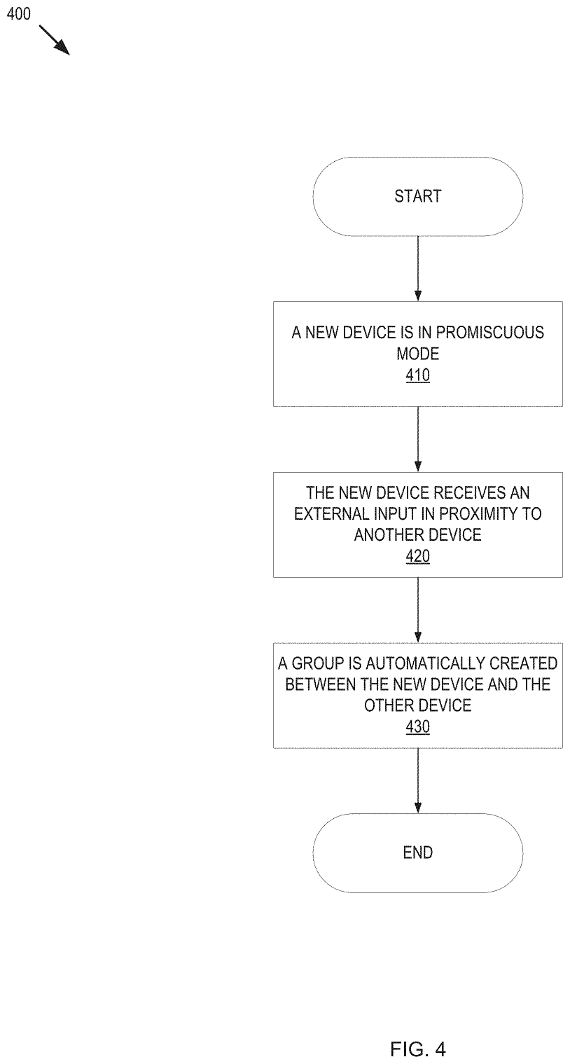

FIG. 4 is a flow diagram of a method 400 of device commissioning that allows devices to be commissioned without use of any additional mobile device or other graphical user interface (GUI) to aid in the configuration of the new devices. Upon completion, devices will inherit the commissioning properties of nearby devices.

At phase 410, a new device is in promiscuous mode. This may be the result of the device having been shipped to a user already in promiscuous mode. When the new device is in close proximity to another device and motion, impact, sound, ambient light, physical proximity, physical placement, orientation such as stacking, or other external inputs are detected, then the new device inherits configuration properties from the other device and is added to the group. At phase 420, the device is placed next to an existing group member and receives an external input, such as a shake from the user. The device may receive a different external input at the discretion of the user. For example, the user may choose to use a different form of external input to activate the transfer of commissioning properties between devices such as turning on the lights in a room, thereby causing the newly shipped device and the other device to perceive ambient light. In some embodiments, on screen pairing is not required. At phase 430, a group is automatically created from the effects of the external input on the devices, and the new device inherits the configuration from the group, creates a new group, or modifies an existing group. In some embodiments, the user can stack (optionally use a fixture), arrange, or group multiple devices to create new group or add devices to an existing group. In some embodiments, various behaviors and network tasks can be defined and altered based on device positions on surfaces.

In an embodiment, commissioning properties may be modified and devices may be reconfigured based on the detection of external inputs such as motion, impact, sound, ambient light, or others. In some embodiments, there are one or more nearby devices present, and once an external input is detected, the new device may acquire properties of the nearby device. In another embodiment, there are no nearby devices present, and once an external input is detected, the new device may allow the user to manually reconfigure the commissioning properties through a mobile application.

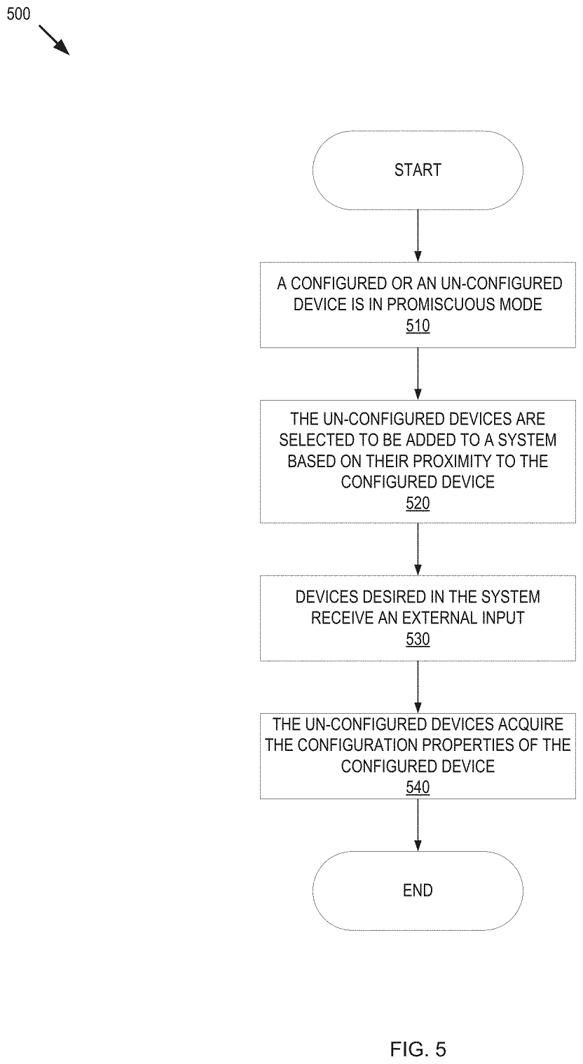

FIG. 5 is a flow diagram of a method 500 of device commissioning that enables configured and un-configured devices to become part of the same group and inherit common default properties. At phase 510, a configured or un-configured device is set to promiscuous mode by having a user press a button on the devices or via other means such as running software. In some embodiments, these un-configured devices are in low-power mode consuming microamps of current. At phase 520, the un-configured devices are selected based on their proximity to the configured device in promiscuous mode. Proximity and location of devices or items can be indicated through RSSI or other means by using signals from existing wireless products, such as BLE, cellular, and so on. For instance, using the BLE signal RSSI, angle of arrival, time difference of arrival, and other RF characteristics from an existing device, such as a BLE headset, the location may be determined. By using one of these options, no new firmware or hardware is required, thereby leveraging existing properties of the devices. In another embodiment, a user determines what un-configured devices should be added to the system regardless of physical proximity. At phase 530, the configured device in promiscuous mode and one or more un-configured device(s) receive an external input from the user such as a mild shock g-force by being tossed on a surface or other means such as being tapped against the user's body. As a result of phase 530, the un-configured and configured devices will wake up upon the g-force shock impact through use of an accelerometer, ball bearings, or other means. This allows for devices to be grouped into a network in an ad hoc fashion with no address, domains or detailed configuration. As a result, this method for networking enables reconfiguration of an existing network with minimal technical knowledge. In some embodiments, this type of networking can be used for project kitting, athletic events, camping, boating, production lines, network operations centers as well as many other events and activities. At phase 540, the un-configured devices will acquire the configuration properties of the configured device upon waking from sleep mode and receiving notification from the configured device. In the event an un-configured device is placed in promiscuous mode, all participating devices become part of the same group and inherit common default properties.

In some embodiments, items may be managed through a group or a given activity. Additionally, common group behaviors once device commissioning has been established may include notifications based on movement or separation though sound, ultrasonic, light, variable signage, or others. Notifications may also include other targeted messaging such as advertising based upon data collected by the system or once a certain threshold has been reached. Other methods of notifications may include manual or automated computer notifications, tablet notifications, cell phone notifications, user device notifications, short message service (SMS) messages, emails, etc. when changes of state are detected by the system. Such changes in state may include temperature change, motion of items such as items moving in and out of areas or moving on or off surfaces or moving to a distant or nearby location or moving into or out of a Smart container, level sensing of contents in a container such as water in a drinking glass or fluid levels for industrial equipment, chemical composition of solids, fluids, gases and/or other items such as a change in the item's pH level, changes in battery level, and other physical and non-physical properties. In an embodiment, notifications may be customized by time, calendar schedule, location of the users and devices. Other devices within the same group our other groups may also receive one or more notifications as a result of a change in state.

In another embodiment, the movement of an item would trigger a notification to a user device and create a list of other things associated with that set. For example, items being placed in a car may be detected through LED, audible, or tactile indicators, and then an audit would occur to ensure that all related items are in the car. Through this way, the movement of a tool or item could trigger the identification of what task is being done such as an oil change. Therefore, other tools needed to conduct an oil change may be suggested via a notification to the user device. In another example, the movement of one or more ingredients could identify what task is being done such as baking a cake or cooking a savory meal. Alternatively, this classification and identification of items can be augmented by knowing the location of an item that belongs to a specific section of a supermarket, for example. The resulting data needed to generate such notifications may be synthesized through the use of multiple sensor types and algorithms. More generally than the specific examples above, a defined set of items may be grouped in a collection and where all of the items are to remain in close proximity to each other within a geographic area. If an item of the collection moves out of a collection (e.g., container) without other items in the collection, then an alert may be sent to a device (e.g., mobile application on a mobile device).

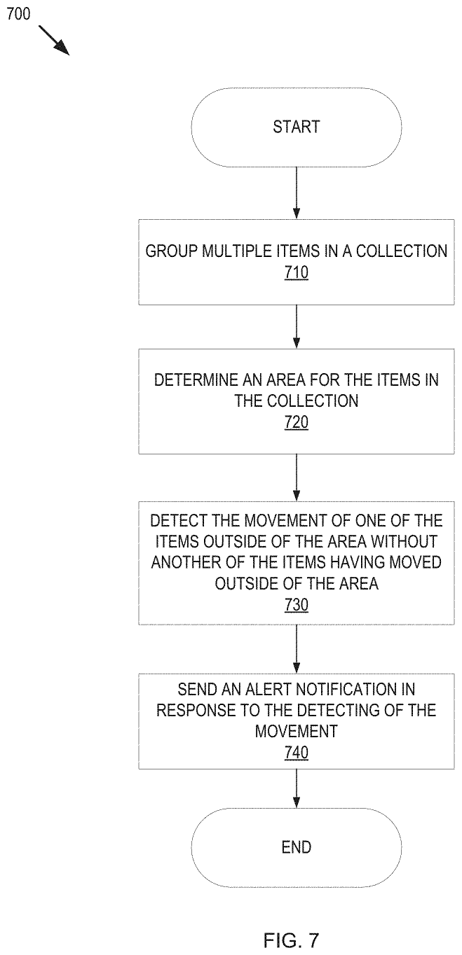

FIG. 7 illustrates one embodiment of a methodology 700 of keep together functionality as discussed above. In this illustrative embodiment, at phase 710, processing logic groups multiple items into a collection of items (e.g., a smart container) For example, an inventory of items in a particular keep together group may be made in a smart container (e.g., Item 1, Item 2 . . . Item n). One or more items may be tracked using Smart Containers and Smart Tags as discussed above. Determining whether an item is in a smart container can be accomplished using various techniques such as RSSI, triangulation, RFID, drone location mapping, etc. At phase 720, processing logic determines an area for the items in the collection. At phase 730, processing logic detects that movement of one of the items outside of the area without another of the items having moved outside of the area. For example, Item 1 may be included in Smart Container 1 with all the other items in the keep together group. Item 1 may then be removed from Smart Container 1 and not located inside Smart Container 1 or is placed in another Smart Container such as Smart Container 2. At phase 740, the processing logic sends an alert notification in response to the detecting of the movements. For example, upon detecting that item 1 is no longer in Smart Container 1, an alert notification of change of location of item 1 may be sent to user, for example, one or more of: a user's mobile app, an online portal, or via Short Message Service (SMS) messaging to a user. In one embodiment, an on demand audit of items and locations may be performed and report generating and sent out that certain ones of the items that are not in their proper locations. For example, a user may place their camera gear into the car to go on a photo shoot. The above described methodology detects that the tripod is not in the car with the other keep together photo shoot items and sends a notification to the user.

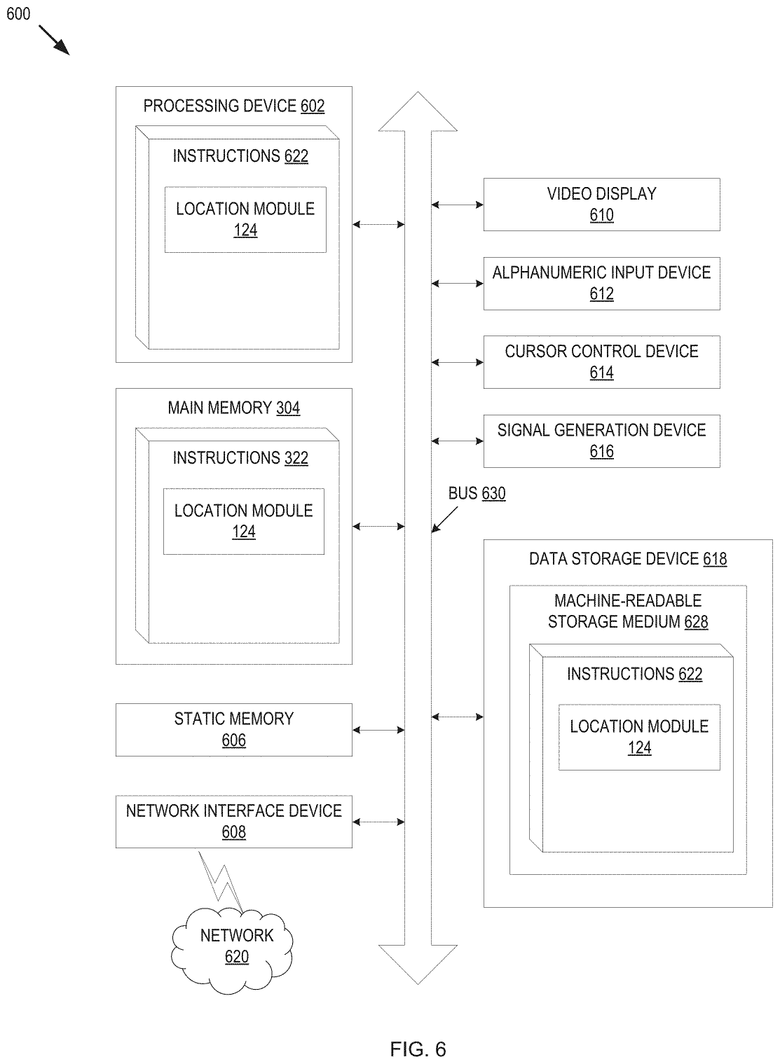

FIG. 6 illustrates an example machine of a computer system 600 within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The exemplary computer system 600 includes a processing device 602, a main memory 604 (e.g., read-only memory (ROM), flash memory, dynamic random access memory (DRAM) such as synchronous DRAM (SDRAM) or DRAM (RDRAM), etc.), a static memory 606 (e.g., flash memory, static random access memory (SRAM), etc.), and a data storage device 618, which communicate with each other via a bus 630. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Processing device 602 represents one or more general-purpose processors such as a microprocessor, a central processing unit, or the like. More particularly, the processing device may be complex instruction set computing (CISC) microprocessor, reduced instruction set computing (RISC) microprocessor, very long instruction word (VLIW) microprocessor, or processor implementing other instruction sets, or processors implementing a combination of instruction sets. Processing device 302 may also be one or more special-purpose processing devices such as an application specific integrated circuit (ASIC), a field programmable gate array (FPGA), a digital signal processor (DSP), network processor, or the like. The processing device 602 is configured to execute instructions 622 for performing the operations and steps discussed herein.

The computer system 600 may further include a network interface device 608. The computer system 600 also may include a video display unit 610 (e.g., a liquid crystal display (LCD) or a cathode ray tube (CRT)), an alphanumeric input device 612 (e.g., a keyboard), a cursor control device 614 (e.g., a mouse), and a signal generation device 616 (e.g., a speaker).

The data storage device 618 may include a machine-readable storage medium 628 (also known as a computer-readable medium) on which is stored one or more sets of instructions 622 (e.g., software) embodying any one or more of the methodologies or functions described herein, including instructions to cause the processing device 602 to execute a system (e.g., server computing system 126). The instructions 622 may also reside, completely or at least partially, within the main memory 604 and/or within the processing device 602 during execution thereof by the computer system 600, the main memory 604 and the processing device 602 also constituting machine-readable storage media.

In one implementation, the instructions 622 include instructions for a location module (e.g., location module 124 and/or a software library containing methods that call modules or sub-modules in a location module). While the machine-readable storage medium 628 is shown in an example implementation to be a single medium, the term “non-transitory computer-readable storage medium” or “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media and magnetic media. Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “sorting” or “performing” or “locating” or “receiving” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct a more specialized apparatus to perform the method. The structure for a variety of these systems will appear as set forth in the description below. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing specification, implementations of the disclosure have been described with reference to specific example implementations thereof. It will be evident that various modifications may be made thereto without departing from the broader spirit and scope of implementations of the disclosure as set forth in the following claims. The specification and drawings are, accordingly, to be regarded in an illustrative sense rather than a restrictive sense.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular embodiments may vary from these exemplary details and still be contemplated to be within the scope of the present disclosure.

Reference throughout this specification to “one embodiment” or “an embodiment” means that a particular feature, structure, or characteristic described in connection with the embodiments included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or”.

Additionally, some embodiments may be practiced in distributed computing environments where the machine-readable medium is stored on and or executed by more than one computer system. In addition, the information transferred between computer systems may either be pulled or pushed across the communication medium connecting the computer systems.

Embodiments of the claimed subject matter include, but are not limited to, various operations described herein. These operations may be performed by hardware components, software, firmware, or a combination thereof.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent or alternating manner.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

What is claimed is:

1. A method, comprising:
grouping a plurality of items in a collection;
determining an area for the plurality of items in the collection;
detecting the movement of one of the plurality of items outside of the area without another of the plurality of items having moved outside of the area; and
sending an alert notification in response to the detecting of the movement.

2. The method of claim 1, further comprising determining whether the one of the plurality of items is in the area.

3. The method of claim 1, wherein sending comprises sending the alert notification to a mobile application.

4. The method of claim 1, wherein sending comprises sending the alert notification to an online portal.

5. The method of claim 1, wherein the alert notification is an SMS message.

6. The method of claim 1, further comprising performing an audit of the plurality of items in the container by detecting whether each of the plurality of items are in the container and generating a report of ones of the plurality of items that are not detected to be in the container.

7. The method of claim 6, further comprising sending a second alert notification based on the report.

8. The method of claim 7, wherein sending the second alert notification comprises sending the second alert notification to at least one of a mobile application and an online portal.

9. A method, comprising:
deploying a drone comprising one or more sensors;
collecting data using the one or more sensors of the drone; and
creating a map of an area using the collected data.

10. The method of claim 9, wherein the map is at least one of a 2D map or a 3D map.

11. The method of claim 9, wherein the drone is configured to traverse a fixed path in the area to generate the map.

12. The method of claim 9, wherein the drone is configured to follow a target, using the one or more sensors, in the area to generate the map.

13. The method of claim 9, further comprising:
detecting, using the one or more sensors, an event; and
activating the done in response to the detecting of the event.

14. The method of claim, 13, wherein the event is a detection of a facial recognition of a user entering the area.

15. The method of claim 13, wherein the event detection of the movement of the drone.

16. The method of claim 9, wherein the drone comprises one of an unmanned aerial vehicle, an unmanned ground based vehicle, or an unmanned fluid based vehicle.

17. An apparatus, comprising:
an object;
an array sensors disposed on the object and configured to sense one or more parameters of material associated with the object;
a communication device disposed on the object to transmit data related to the one or more parameters of the material of the object.

18. The apparatus of claim 17, wherein the array of sensors comprises one or more of the following: a moisture sensor, a light sensor, a turbidity meter, a temperature sensor, a pressure sensor, a resistance measurement sensor, a float position sensor, and a liquid level sensor, an image sensor.

19. The apparatus of claim 17, wherein the object is plate.

20. The apparatus of claim 17, wherein the object is a drinking device.
